(19) United States
(12) Patent Application Publication
(10) Pub. No.: US 2006/0138713 A1
(43) Pub. Date: Jun. 29, 2006

(54) Process for preparing dispersion additives useful for corrosion protective coatings

(75) Inventors: Radhakrishnan Subramaniam, Maharashtra (IN); Vishwambharan R. Vattoliparambil, Maharashtra (IN)

Correspondence Address: NIXON & VANDERHYE, PC, 901 NORTH GLEBE ROAD, 11TH FLOOR, ARLINGTON, VA, 22203, US

(73) Assignee: COUNCIL OF SCIENTIFIC AND INDUSTRIAL RESEARCH, New Delhi (IN)

(21) Appl. No.: 11/022,919

(22) Filed: Dec. 28, 2004

(51) Int. Cl. H05B 7/00

(52) U.S. Cl. 264/484

(57) ABSTRACT

The present invention relates to modification of dispersions using nano-paticulate additives having appropriate composition, which can be used for coatings for sheets/substrates made of steel, to prevent corrosion due to saline water.

### FIELD OF THE INVENTION

The present invention relates to a process for preparing dispersion additives useful for corrosion protective coatings. More particularly the present invention relates to modification of dispersions using nano-particulate additives having appropriate composition, which can be used for coatings for sheets/substrates made of steel, to prevent corrosion due to saline water,

### BACKGROUND OF THE INVENTION

Corrosion protection of metallic substrates, in particular iron and steel, is important in many areas of application. The exposure of the metals such as steel to harsh environments, especially seawater, causes rapid oxidation leading to rust formation and degradation of the material properties. In order to prevent this, the metals are usually coated with polymer based coatings or paints. These coatings are commonly made by dispersion of fine pigments in an organic medium containing solvent, binder, polymer and drying agent. In the practice of corrosion control, as applied to ferrous substrates, zinc based compounds are known to give good results due to galvanically sacrificial tendency. Certain additives such as zinc oxide, iron oxide etc., which impart extra corrosion resistance may be incorporated in these dispersions for coatings.

In the prior art described in several patents (U.S. Pat. Nos. 4,086,096, 4,246,030, 4,217,142, 2,816,051, 4,626,283, 4,774,345) the coating formulation is prepared by the addition of corrosion inhibitor such as zinc oxide, zinc chromate, zinc dust, zinc salt complexed with amine and other zinc based compounds to the polymer (alkyd, acrylic, urethane etc.) solution or dispersion in an organic medium in the range of 40 to 50 wt %, and mixing/grinding/ball milling the same to obtain a slurry or paint. However, these types of conventional dispersions are limited by the large amount of filler, additive etc. which causes problems in mixing because of viscosity and stability due to settling of suspended particles over short time. Additional costly dispersing agents also need to be added in order to prevent particle settling. Further, after exposure to harsh environment such as seawater (saline water) these coatings tend to crack especially due to high inorganic additive content. Repeated application of coating is needed to protect substrate from corrosion which is not only time consuming and costly but also leads to deterioration of aesthetic appearance.

### Objects Of The Invention The main object of the invention is to provide a process for preparation of dispersion additives useful for corrosion protective coatings.

### SUMMARY OF THE INVENTION

Accordingly the present invention provides a process for the preparation of dispersion additives useful for corrosion protective coatings, the process comprising which comprises dissolving a polymer having ether or amine groups in a solvent, adding a metal salt dissolved separately in the same solvent in desired proportion in order to form a complex by digestion of the polymer and the metal salt, reacting the complex with an alkali to form a colloidal precipitate, separating the precipitate from the reaction mixture, drying the separated precipitate and grinding to fine powder to form a dispersion additive useful for corrosion protective coating.

In one embodiment of the invention, the complex is reacted with the alkali for a period in the range of 4 to 8 hrs and at a temperature in the range of 10° C. to 30° C.

In another embodiment of the invention, the precipitate is separated from the reaction mixture by centrifugation or filtration.

In yet another embodiment of the invention, the polymer used for complex formation contains ether, hydroxyl or amine groups and has a molecular weight in the range of 30000 to 200000.

In yet another embodiment of the invention, the polymer is selected from the group consisting of polyethylene oxide, polyethylene glycol, polyether amine and polyglycol esters In another embodiment of the invention, the metal salt used for complex formation contain high electronegative anions and bi or trivalent transition metal cations.

In another embodiment of the invention, the metal salt is selected from the group consisting of chloride, bromide, chromate and acetate salts of a metal selected from the group consisting of zinc, iron(III), nickel (III) and chromium.

In another embodiment of the invention, the concentration of polymer solution used for complex formation is in the range of 5 to 35 wt %.

In another embodiment of the invention, the concentration of metal salt used for complex formation is in the range of 4 to 10 wt % in the solvent.

In another embodiment of the invention, the metal solution is used in a molar ratio in the range of ¼ to 1/32 of the polymer.

In another embodiment of the invention, the alkali is soluble in the solvent chosen as reaction medium and has a pH>8.

In another embodiment of the invention, the alkali is selected from the group consisting of sodium hydroxide, potassium hydroxide and liquid ammonia.

In another embodiment of the invention, the fine additive powder has particle size in the range of 2 nano-meters to 50 nano-meters preferably 3 to 5 nano-meters,

### DETAILED DESCRIPTION OF THE INVENTION

The present invention provides a process for preparing dispersion additives useful for corrosion protective coatings. The process of the invention comprises dissolving a polymer having ether or amine groups in a solvent followed by addition of a metal salt dissolved separately in the same solvent in desired proportion. The polymer and the salt are allowed to digest for an extended period to form a complex. This complex is reacted with an alkali for 4 to 8 hrs at a temperature ranging from 10° C. to 30° C. so as to form a colloidal precipitate. This precipitate is separated by centrifugation or filtration and then dried and ground to fine powder to obtain the additive useful for dispersion coating of steel substrates.

The polymer used for complex formation contains ether, hydroxyl and amine groups with a molecular weight in the range of 30000 to 200000 and is chosen from polyethylene oxide, polyethylene glycol, polyether amine or polyglycol esters. The metal salt used for complex formation contain high electronegative anions and bi or trivalent transition metal cations and is chosen from chloride, bromide, chromate, acetate of zinc, iron(III), nickel (III) and chromium. The concentration of polymer solution used for complex formation is in the range of 5 to 35 wt %. The concentration of metal solution used for complex formation is in the range of 4 to 10 wt.% in the solvent and in molar ratio of ¼ to 1/32 of the polymer. The alkali used for the reaction has high solubility in the solvent chosen as the reaction medium with ph>8 and is chosen from sodium hydroxide, potassium hydroxide or liquid ammonia. The fine powder of the additive has particle size in the range of 2 nano-meters to 50 nano-meters preferably 3 to 5 nano-meters. In a feature of the present invention the additive useful for corrosion resistant coating is added to another polymer solution and mixed by conventional methods in the range of 2 to 5 wt % and coated on metal substrates by dipping the substrate in the solution.

The process of the invention is described hereinbelow with reference to illustrative examples, which should not be construed to limit the scope of the invention in any manner.

### EXAMPLE-1

Polyethylene glycol (17.6 gm) with M.W. 35000 was first dissolved in pure methanol (150 ml) and stirred thoroughly for 4 hrs to form homogenous viscous solution (A). In another glass vessel 13.6 gm of zinc chloride were dissolved in 50 ml of methanol to form solution (B). This solution was poured in solution A and the two mixed thoroughly for 1 hr. to form mixture (C). The mixture was kept at room temperature for 12 hr without stirring. 8.0 g of sodium hydroxide were dissolved in 100 ml of pure water and the alkali solution was slowly poured in (C) from sides without stirring and the whole reaction mixture kept at 25C. for 20 hr without disturbance. The colloidal precipitate was formed in the reaction mixture which was dumped in 300 ml of water. The precipitate was separated by repeated centrifugation, flushing with water, decanting and then filtering the same using Whatman filter paper. The white precipitate was dried at 60° C. for 24 hrs and then the cake crushed using agate pestle mortar to form fine powder. This was tested for corrosion resistance property by the procedure as described in the present invention.

### EXAMPLE-2

Polyethylene glycol (26.4 gm) with M.W. 35000 was first dissolved in pure methanol (150 ml) and stirred thoroughly for 4 hrs to form homogenous viscous solution (A). In another glass vessel 13 gm of zinc chloride were dissolved in 50 ml of methanol to form solution (B). Solution B was poured in solution A and the two were mixed thoroughly for 1 hr. to form mixture (C). The mixture was kept at room temperature for 12 hr without stirring. 80 g of sodium hydroxide were dissolved in 100 ml of pure water and the alkali solution was slowly poured in (C) from sides without stirring. The whole reaction mixture kept at 25° C. for 20 hr without disturbance. Colloidal precipitate was formed in reaction mixture which was dumped in 300 ml of water. The precipitate was separated by repeated centrifugation, flushing with water, decanting and then filtering the same using Whatman filter paper. The white precipitate was dried at 60° C. for 24 hrs and then the cake crushed using agate pestle mortar to form fine powder. This was tested for corrosion resistance property by the procedure as described in the present invention. The results of these tests are given in Table-1.

### EXAMPLE-3

Polyethylene glycol (35.2 gm) with M.W. 35000 was first dissolved in pure methanol (150 ml) and stirred thoroughly for 4 hrs to form homogenous viscous solution (A). In another glass vessel 13 gm of zinc chloride were dissolved in 50 ml of methanol to form solution (B). This solution was poured in solution A and the two mixed thoroughly for 1 hr. to form mixture (C). The mixture was kept at room temperature for 12 hr without stirring. 80 g of sodium hydroxide were dissolved in 100 ml of pure water and the alkali solution was slowly poured in (C) from sides without stirring and the whole reaction mixture kept at 25 C. for 20 hr without disturbance. The colloidal precipitate was formed in the reaction mixture which was dumped in 300 ml of water. The precipitate was separated by repeated centrifugation, flushing with water, decanting and then filtering the same using Whatman filter paper. The white precipitate was dried at 60° C. for 24 hrs and then the cake crushed using agate pestle mortar to form fine powder. This was tested for corrosion resistance property by the procedure as described in the present invention. The results of these tests are given in Table-1.

Testing of corrosion resistance of the coatings using the additive prepared by the process described in the present invention was performed in the following manner: The mild steel substrates (7.5 cm×2.5 cm×1 mm) with rounded edges and polished with emery paper were cleaned thoroughly with water, acetone and dried with hot air blower. The coating solution was made by dissolving 5 g of polyvinyl acetate (M.W. 44000) in 150 ml methanol to which were added the desired amount (0.5 gm) of additive prepared by the process described in the present invention. The whole mixture was stirred by magnetic stirrer for 24 hr. The solvent was allowed to evaporate so as to obtain thick slurry of 50 ml. The steel substrates prepared as above were dip coated (dwell time 30 s) in this slurry, dried thoroughly for 24 hrs and then tested for corrosion resistance. The above procedure was repeated for all the samples of additives prepared in the manner described in Examples 1 to 3 including the commercially available grades of zinc oxide. These coated substrates were tested for corrosion resistance by electrochemical technique using computer controlled potentiostat, three electrode single compartment cell, 0.5 M NaCI aqueous electrolyte and running cyclic voltamerty before and after exposure to saline conditions as required for accelerated testing conditions. The results of these tests are given in Table-1.

TABLE 1
Corrosion resistant properties of coating
using additive of invention

Anodic Current* after exposure
to Corrosive solution (μA)

| | 2 hr | 6 hr | 8 hr | 24 hr |
|---|---|---|---|---|
| Additive Sample | (50° C.) | (50° C.) | (50° C.) | (25° C.) |
| Example - 1 | 125 | 360 | 380 | 3 |
| Example - 2 | 18 | 215 | 215 | 2 |
| Example - 3 | 12 | 46 | 85 | 2 |
| Commercial ** | 3960 | 21000 | 25000 | 840 |

*The coated mild steel plates kept in saline water (0.5 M NaCl) 100 ml at the temperature and duration mentioned in the column. Anodic current was noted in all cases at 500 mV (SCE).
** commercial grade zinc oxide obtained from standard chemical supplier

The values of the anodic currents given in Table-1 clearly indicate that the additive prepared by the process described in the present invention imparts high corrosion resistance of the coating as compared to the commercial grades. The coating containing the dispersion additive prepared by the present invention withstands drastic corrosion environment even for 8 hrs at 50 C. while that containing commercial grade additive fails immediately within 1 hr at this temperature and within 24 hrs at room temperature. Further, it may be pointed out that the anodic currents noted for these additives after the drastic treatment is much lower than the commercial grades with mild treatment. Thus, these additives as obtained from the process described in Examples 1 to 3 are clearly superior to the conventional commercially available grades.

Another advantage of the present process is that these additives can be added in much lower concentrations (2 to 10%) than the conventional grades (50 to 70%) without the loss of corrosion resistance thus giving much higher optical gloss, smoothness etc.

We claim:

1. A process for the preparation of dispersion additives useful for corrosion protective coatings, the process comprising which comprises dissolving a polymer having ether or amine groups in a solvent, adding a metal salt dissolved separately in the same solvent in desired proportion in order to form a complex by digestion of the polymer and the metal salt, reacting the complex with an alkali to form a colloidal precipitate, separating the precipitate from the reaction mixture, drying the separated precipitate and grinding to fine powder to form a dispersion additive useful for corrosion protective coating.

2. A process as claimed in claim 1 wherein the complex is reacted with the alkali for a period in the range of 4 to 8 hrs and at a temperature in the range of 10° C. to 30° C.

3. A process as claimed in claim 1 wherein the precipitate is separated from the reaction mixture by centrifugation or filtration.

4. A process as claimed in claim 1 wherein the polymer used for complex formation contains ether, hydroxyl or amine groups and has a molecular weight in the range of 30000 to 200000.

5. A process as claimed in claim 1 wherein the polymer is selected from the group consisting of polyethylene oxide, polyethylene glycol, polyether amine and polyglycol esters.

6. A process as claimed in claim 1 wherein the metal salt used for complex formation contain high electronegative anions and bi or trivalent transition metal cations.

7. A process as claimed in claim 1 wherein the metal salt is selected from the group consisting of chloride, bromide, chromate and acetate salts of a metal selected from the group consisting of zinc, iron(III), nickel (III) and chromium.

8. A process as claimed in claim 1 wherein the concentration of polymer solution used for complex formation is in the range of 5 to 35 wt %.

9. A process as claimed in claim 1 wherein the concentration of metal salt used for complex formation is in the range of 4 to 10 wt % in the solvent.

10. A process as claimed in claim 1 wherein the metal solution is used in a molar ratio in the range of ¼ to 1/32 of the polymer.

11. A process as claimed in claim 1 wherein the alkali is soluble in the solvent chosen as reaction medium and has a pH>8.

12. A process as claimed in claim 1 wherein the alkali is selected from the group consisting of sodium hydroxide, potassium hydroxide and liquid ammonia.

13. A process as claimed in claim 1 wherein the additive powder has particle size in the range of 2 nano-meters to 50 nano-meters.

14. A process as claimed in claim 1 wherein the additive powder has particle size in the range of 3 to 5 nano-meters.
